(19) United States
(12) Patent Application Publication
(10) Pub. No.: US 2004/0153361 A1
(43) Pub. Date: Aug. 5, 2004

(54) Real value enabler

(76) Inventor: Nicolaas Johannes Smith, Lisbon (PT)

Correspondence Address: Nicolaas Johannes Smith, Rua Raul Proenca, 30, Lisbon, 1400-366, PT

(21) Appl. No.: 10/763,911

(22) Filed: Jan. 26, 2004

Related U.S. Application Data
(60) Provisional application No. 60/442,555, filed on Jan. 27, 2003.

(51) Int. Cl. G06F 17/60

(52) U.S. Cl. 705/10; 705/35

(57) ABSTRACT

This invention is a method and system with steps for the entering of economic values as either nonmonetary or monetary values in electronic format in all computer files and electronic display formats always together with value dates and then for continuously real valuing (updating) (i) dated nonmonetary values to maintain them at constant real economic values over time and (ii) dated monetary values only to indicate the latters' real values in the past at the current rate when this is required, whenever the program accesses them in any way including visual or voice methods and displaying them on any electronic computer or any other electronic device in any form and way including in the form of charts and graphs and when they are printed in a hardcover format or when they are made available in any way including, but not limited to, on a computer screen, a TV screen, mobile phone, computer tablet, PDA or computer sound system.

### CROSS REFERENCE TO RELATED APPLICATION

I wish to claim the benefit of Provisional Application No. 60/442,555 Filing Date Jan. 27, 2003. I wish to particularly point out and distinctly claim the subject matter which I regard as the invention as mentioned in the Provisional Application as mentioned above.

### BACKGROUND

The present invention generally relates to the field of automated data processing technologies and more particularly to the dating of economic values in computer files and the computer real valueing (increasing, hyperincreasing or decreasing, as the case may be) of (i) dated nonmonetary values in computer files to maintain said dated nonmonetary values at constant real economic values over time and (ii) dated monetary values in computer files only to indicate the latters' real values in the past at the current rate, when displaying and/or printing them and/or making them known to a user in any way or form.

The basic fundamental concept behind this invention is that we need to be able to see and deal with the current real values of items in our economies and the world around us and not their, sometimes meaningless and often misleading, historical cost values when we live in cash inflationary, cash hyperinflationary and cash deflationary economies, that is, when we use a monetary unit as the unit of measure in our economies and this monetary unit continuously decreases, hyperdecreases or increases in real value, as the case may be. For example, in a low cash inflationary economy the depreciating monetary unit of account (for example the depreciating US Dollar)—the unitary measure used to account and value all items in the low cash inflationary US Dollar economy—always decreases in real value and we thus have to continuously increase the current values of nonmonetary values since the real price of a nonmonetary real value changes inversely with the change in the real value of depreciating money over time when all else are equal except the real value of depreciating money. Our real economies function in real value terms, not in depreciating, hyperdepreciating or appreciating money terms and when we operate as economic entities we think in current real value terms and not in historical nominal money terms. When they tell us on TV that Marble Arch in London cost 10 000 British Pounds when it was built, it means absolutely nothing to us now (the same happens when a 75 year old grandfather tells us in a live event on CNN that he started working for 25 US Dollars per week 50 years ago). The money illusion, namely the assumption that depreciating money keeps its real value stable over time, is very strong in low inflation economies because it forms part of a fundamental accounting principle. It is basically an economic ‘law’. These economies account for the far greater part of world economic activity.

In a low cash inflationary economy depreciating money is a store of decreasing real value but it is generally assumed to have a stable real value. This assumption is formalised by its actual inclusion in one of the fundamental accounting principles on which our traditional Historical Cost Accounting system is based:

‘The Measuring Unit: The unit of measure in accounting shall be the base money unit of the most relevant currency. This principle also assumes the unit of measure is stable; that is, changes in its general purchasing power are not considered sufficiently important to require adjustments to the basic financial statements.’

Paul H. Walgenbach, Norman E. Dittrich and Ernest I. Hanson, (1973), Financial Accounting, New York: Harcourt Brace Javonovich, Inc. Page 429.

This assumption is now unacceptable. It always was and now still is fundmentally wrong and incredibly costly to the world economy and people in general.

We thus, unfortunately, find that the majority of economic values are presented to us daily in nominal historical cost terms instead of in constant real value terms as a result of the almost universal use of Historical Cost Accounting as the traditional basis of accounting our economic activities in combination with cash inflation, cash hyperinflation and cash deflation. The whole sphere of accounting is a sphere of contracts—either written or implied. Substituting Historical Cost Accounting with Real Value Accounting solves the problem of the destruction and hyperdestruction of real value by Historical Cost Accounting inflation and Historical Cost Accounting hyperinflation, and the creation of value by Historical Cost Accounting deflation, in nonmonetary values, as applicable, for an unlimited period of time. Real Value Accounting however only automatically real values all nonmonetary accounting values in accounting computer files when they are processed/accessed/transferred/displayed or printed over time, and all accounting monetary values in accounting computer files, only when the latter are displayed/printed or made available in any form after the reporting date of financial statements, but only when we are using an accounting software package or system that is based on Real Value Accounting, which is the subject of a previous provisional patent application submitted to the USPTO on Jun. 1, 2003 under the name Real Value Accounting Practice.

The present invention is a method and system with steps for the capturing/entering/recording/inputting of economic values as either nonmonetary or monetary values in computer files always together with value dates and then for continuously real valuing (updating) (i) dated nonmonetary values to maintain said dated nonmonetary values at constant real economic values over time and (ii) dated monetary values only to indicate the latters' real values in the past at the current rate when this is required, whenever the program accesses them in any way including visual or voice methods and displaying them on any electronic computer device in any form and way including in the form of charts and graphs and when they are printed in a hardcover format or when they are made available in any way including, but not limited to, on a computer screen, a TV screen, computer tablet, PDA or computer sound system, for example.

Since this invention is based on a new analysis of inflation, hyperinflation and deflation that is not yet generally accepted, a full description of the new analysis is provided as follows:

It has always been accepted that inflation is a sustained rise in the general level of prices, that hyperinflation is a sustained hyperincrease in the general level of prices and that deflation is a sustained fall in the general level of prices.

This invention is based on a new analysis of the forms in which inflation, hyperinflation and deflation are manifested in our economies and makes a distinction between the one form being an economic process and the other form being the result of an accounting practice in each particular case.

Inflation manifests itself in two forms: in the form of Cash inflation and in the form of Historical Cost Accounting inflation. In both forms of inflation real economic value is destroyed over time. Cash inflation is an economic process, which destroys real economic value in monetary values over time, while Historical Cost Accounting inflation is the result of an accounting practice, which destroys real economic value in nonmonetary values over time.

In an inflationary economy we have the following:

1.) Cash inflation which is always and everywhere the destruction of real economic value in depreciating money and depreciating monetary values over time as indicated by the change in the Consumer Price Index and

2.) Historical Cost Accounting inflation which is always and everywhere the destruction of real economic value in nonmonetary values not real valued (increased) over time due to the use of the Historical Cost Accounting practice or any other accounting practice which does not permit the constant real valuing of all nonmonetary values in an economy subjected to cash inflation.

Hyperinflation manifests itself in two forms: in the form of Cash hyperinflation and in the form of Historical Cost Accounting hyperinflation. In both forms of hyperinflation real economic value is hyperdestroyed over time. Cash hyperinflation is an economic process which hyperdestroys real economic value in monetary values over time and Historical Cost Accounting hyperinflation is the result of an accounting practice which hyperdestroys real economic value in nonmonetary values over time.

In a hyperinflationary economy we have the following:

3.) Cash hyperinflation which is always and everywhere the hyperdestruction of real economic value in hyperdepreciating money and hyperdepreciating monetary values over time as indicated by the change in the Consumer Price Index and

4.) Historical Cost Accounting hyperinflation which is always and everywhere the hyperdestruction of real economic value in nonmonetary values not real valued (hyperincreased) over time due to the use of the Historical Cost Accounting practice or any other accounting practice which does not permit the constant real valuing (hyperincreasing) of all nonmonetary values in an economy subjected to hyperinflation.

Deflation manifests itself in two forms: in the form of Cash deflation and in the form of Historical Cost Accounting deflation. In both forms of deflation real economic value is created over time. Cash deflation is an economic process, which creates real economic value in monetary values over time, and Historical Cost Accounting deflation is the result of an accounting practice, which creates real economic value in nonmonetary values over time.

In a deflationary economy we have the following:

5.) Cash deflation which is always and everywhere the creation of real economic value in appreciating money and appreciating monetary values over time as indicated by the change in the Consumer Price Index and

6.) Historical Cost Accounting deflation which is always and everywhere the creation of real economic value in nonmonetary values not real valued (decreased) over time due to the use of the Historical Cost Accounting practice or any other accounting practice which does not permit the constant real valuing (decreasing) of all nonmonetary values in an economy subjected to cash deflation.

The above is due to the fact that:

A) In an inflationary economy

where depreciating money is used as the depreciating monetary unit of account over time all monetary values have depreciating real economic values—as indicated by the change in the Consumer Price Index—as a result of the economic, political, monetary and social policies in that economy. These depreciating monetary values can not now be physically real valued (updated) over time, firstly, as a result of the fact that depreciating bank notes and depreciating bank coins have their fixed nominal values permanently printed or molded onto them and, secondly, as a result of the fact that depreciating accounted monetary values have the same attributes as depreciating money with the single exception that they are not physical depreciating notes and physical depreciating coins, but depreciating accounted monetary values; and

all nonmonetary values

have constant real economic values over time but are accounted also using depreciating money as the depreciating monetary unit of account with the result that these constant nonmonetary real values have to be real valued (increased) over time at the rate of cash inflation to reflect the decrease in the real value of the depreciating monetary unit of account since, over each and every period of time, the real price of a nonmonetary real value changes inversely with the change in the real value of depreciating money, when all else are equal except the real value of depreciating money.

B) In a hyperinflationary economy

where hyperdepreciating money is used as the hyperdepreciating monetary unit of account over time all monetary values have hyperdepreciating real economic values—as indicated by the hyperchange in the Consumer Price Index—as a result of the economic, political, monetary and social policies in that economy. These hyperdepreciating monetary values can not now be physically real valued (updated) over time, firstly, as a result of the fact that hyperdepreciating bank notes and hyperdepreciating bank coins have their fixed nominal values permanently printed or molded onto them and, secondly, as a result of the fact that hyperdepreciating monetary values have the same attributes as hyperdepreciating money with the single exception that they are not physical hyperdepreciating notes and physical hyperdepreciating coins, but accounted hyperdepreciating monetary values; and

all nonmonetary values

have constant real economic values over time but are accounted also using hyperdepreciating money as the hyperdepreciating monetary unit of account with the result that these constant nonmonetary real values have to be real valued (hyperincreased) over time at the rate of cash hyperinflation to reflect the hyperdecrease in the real value of the hyperdepreciating monetary unit of account since, over each and every period of time, the real price of a nonmonetary real value changes inversely with the change in the real value of hyperdepreciating money, when all else are equal except the real value of hyperdepreciating money.

C) In a deflationary economy

where appreciating money is used as the appreciating monetary unit of account over time all monetary values have appreciating real economic values—as indicated by the change in the Consumer Price Index—as a result of the economic, political, monetary and social policies in that economy. These appreciating monetary values can not now be physically updated over time, firstly, as a result of the fact that appreciating bank notes and appreciating bank coins have their fixed nominal values permanently printed or molded onto them and, secondly, as a result of the fact that appreciating accounted monetary values have the same attributes as appreciating money with the single exception that they are not physical appreciating notes and physical appreciating coins, but appreciating accounted monetary values; and

all nonmonetary values

have constant real economic values over time but are accounted also using appreciating money as the appreciating monetary unit of account with the result that these constant nonmonetary real values have to be real valued (decreased) over time at the rate of cash deflation to reflect the increase in the real value of the appreciating monetary unit of account since, over each and every period of time, the real price of a nonmonetary real value changes inversely with the change in the real value of appreciating money, when all else are equal except the real value of appreciating money.

It is generally accepted and well known that cash inflation destroys real value in depreciating money and depreciating monetary values, that cash hyperinflation hyperdestroys real value in hyperdepreciating money and hyperdepreciating monetary values and that cash deflation creates real value in appreciating money and appreciating monetary values over time.

The destruction and hyperdestruction of real value in nonmonetary values by Historical Cost Accounting inflation and Historical Cost Accounting hyperinflation, respectively, and the creation of real value in nonmonetary values by Historical Cost Accounting deflation are further explained as follows:

A nonmonetary value has a constant real value over time. When it is never real valued (increased) over time, when an economic entity uses Historical Cost Accounting in a cash inflationary economy or cash hyperinflationary economy, it in reality takes on an attribute of a monetary value, i.e., a fixed nominal historical cost value subject to the same well known destruction or hyperdestruction of real value over time as in all monetary values.

In a deflationary economy a nonmonetary value also has a constant real value over time. When it is never real valued (decreased) over time in an deflationary economy it in reality takes on an attribute of a monetary value in a deflationary economy, i.e., a fixed nominal historical cost value subject to the same well known creation of real value over time as in all monetary values in a deflationary economy.

Real economic value is created in all nonmonetary values not real valued (decreased) over time in a deflationary economy when Historical Cost Accounting is used by an economic entity.

It is well known that a high rate of cash inflation, any rate of cash hyperinflation as well as any rate of cash deflation are all undesirable economic processes. Likewise, the destruction of real nonmonetary value by Historical Cost Accounting inflation and Historical Cost Accounting hyperinflation as well as the creation of real nonmonetary value by Historical Cost Accounting deflation are undesirable losses and profits resulting from the use by an economic entity of Historical Cost Accounting or any other accounting practice which does not permit the continuous real valuing (increasing or decreasing, as the case may be) of all real nonmonetary values over time in a cash inflationary, a cash hyperinflationary and a cash deflationary economy, as applicable.

Real value is based on the combined result of all the underlying value systems in an economy, including but not limited to the economic system, the monetary system, the political system, the social system, the educational system, the defense system, the health system, the security system, the legal system, the justice system, the accounting system, and so on, to name but a few.

The change in the local Consumer Price Index is determined by the change in the real value of the local monetary unit of account over time in the local economy. The software is preprogrammed with the level for the CPI for the local economy being that CPI related to the currency in which the economic entity conducts its economic activities and which it uses as its monetary unit of account to account its economic affairs. The number of years of past data for the CPI to be preloaded is determined by the time period that an economic entity estimates that it will need the preloaded data for.

In a cash hyperinflationary economy the level of the CPI changes daily by up to 5 percent or more, but it is not officially available till a month and a half or two months later. What is used to real value (update) nonmonetary values on a daily basis is the exchange rate of a relatively stable foreign currency. This is almost always the depreciating US Dollar exchange rate. It can also be the relatively stable depreciating Euro or any other relatively stable depreciating foreign currency. There are normally at least two depreciating US Dollar exchange rates being used in a cash hyperinflationary economy. The one is the official depreciating US Dollar exchange rate published by the Central Bank or a government agency. It is not to be used with this invention as it is normally not the real exchange rate of the depreciating US Dollar in a cash hyperinflationary economy. The one to be used is the street rate or black market rate that is determined in the streets by confirming the daily black market rate in various markets in the capital city. You have to communicate by mobile radio or mobile phone with traders in the various markets to determine the street rate for the day. There is normally only one daily rate used throughout the capital city or region. This is the correct real exchange rate of the depreciating US Dollar to be entered on a daily basis with this invention in a cash hyperinflationary economy. The hyperdepreciating local currency in a cash hyperinflationary economy is normally only used as a hyperdepreciating national unit of exchange. It has almost no store of hyperdepreciating value function (it only has a daily store of value function) and should never be used as a hyperdepreciating unit of account to prepare any financial reports or operating results on a Historical Cost Accounting basis. Historical Cost Accounting financial reports prepared on the basis of a hyperdepreciating monetary unit of account are completely meaningless in a cash hyperinflationary economy. As soon as the cash hyperinflationary economy passes into a low cash inflationary economy mode, the CPI can be used instead of the depreciating US Dollar exchange rate for real valuing (updating) nonmonetary values.

In a low cash inflation or low cash deflation economy the latest level of the CPI is normally only available a month and a few days after the month to which it relates. The level to be entered is the latest level available. The daily level of the CPI is calculated by assuming that the change in the CPI occurs evenly over the time period for which the change in the CPI is made available. This calculation is preprogrammed. All that is required is to enter the latest change (or actual level of the CPI, as applicable) in the CPI as soon as it is officially available.

Monetary values are depreciating money and depreciating monetary values, hyperdepreciating money and hyperdepreciating monetary values and apprecaiting money and appreciating monetary values, as applicable. Examples of depreciating or appreciating monetary values are bank notes and bank coins, demand deposit bank balances, the capital amounts of all bank or other money loans made to an economic entity or received from an economic entity whether an entity (the bank, for example) pays or receives interest or not.

All other values are nonmonetary values and include all other balance sheet nonmonetary assets and nonmonetary liabilities and all values in the profit and loss account. Nonmonetary values include paid up share capital, trade receivables, trade payables, dividends payable, dividends receivable, profits, losses, taxes, rent, interest, salaries, wages, retained profits, retained losses, shareholders' interest, etc.

A real nonmonetary value, for example a trade receivable's value for a sale of goods, services or rights always payable in depreciating, hyperdepreciating or appreciating money is not a depreciating, hyperdepreciating or appreciating monetary value just because it is always paid in the form of depreciating, hyperdepreciating or appreciating money. Depreciating, hyperdepreciating or appreciating money is only the agreed upon depreciating, hyperdepreciating or appreciating monetary medium of exchange for that constant real nonmonetary value. A trade receivable originating from the sale of an item with a nonmonetary value, is always a nonmonetary value [it has to be real valued (updated) over time] up to the moment of the payment of the nonmonetary value in depreciating, hyperdepreciating or appreciating money. After the payment in depreciating, hyperdepreciating or appreciating money it is not a nonmonetary debt (trade receivable) any more. It is then, and only as from then, a depreciating, hyperdepreciating or appreciating monetary value, which can be kept in that nominal unupdatable form or it can be exchanged for a new nonmonetary value to be real valued (updated) over time.

A financial statement of account is a snapshot of an economic entity's real financial position at a specific day of the financial year. Current period monetary values are presented in those financial statements as monetary values [not real valued (updated)] only on that actual day. At any date after the actual date of the financial statements, monetary values are real valued (updated)—only in the financial reports and not in the actual ledger accounts—the same as nonmonetary values because the financial statements then relate to the real financial position of the economic entity at a specific date—in the past. It is a snapshot of a static situation in the past.

A monetary value is never real valued (updated) while it is a monetary value in the actual ledger account of an economic entity. The balance sheet is not a ledger account and there are no monetary values in the profit and loss account, of which the profit and loss statement is a direct copy. The net monetary loss or gain under Real Value Accounting is transformed into a nonmonetary value the moment it is calculated and recorded in the accounts of an economic entity and has to be real valued (updated) over time.

Prior period comparative values and normal budget values are all (monetary and nonmonetary values) updated at the current date rate and displayed and/or printed at current date values. Care must be taken to understand that monetary values at prior dates and as budget values are updated the same as nonmonetary values—only for comparison purposes—but never in an actual account situation.

A depreciating, hyperdepreciating or appreciating monetary value has a real value at a specific moment in time but this real value changes continuously. A monetary value is not a constant real value over time. A monetary value has a changing real value over time. The next moment or day it is a different real value for that moment or that day in time in a cash inflationary, cash hyperinflationary or cash deflationary economy, as applicable. It all depends on the level of accuracy required. All nonmonetary values maintain their relative real values constant over time in an economy.

When a monetary value appearing in a pre-set budget prepared at a specific date or as a prior period figure is presented, displayed or printed at any time after the prior period date or after the date the original budget was prepared, then it is the real value, which the monetary value represented at that prior period date or at the date the budget was originally prepared, that is updated for comparison purposes only.

Updated values are not market values. Updated values are real values updated over time at the rate of change in the CPI. Updated values' spot values are only determined in an actual transaction in the market.

There is thus a need to see/access/display/print and deal with economic values at their current real values over time. Since we do not have stable money and since it never existed in the past we have to record all past and present economic values always with a value date in all computer files. This will allow us to real value (update) these dated values correctly by applying the change in the level of the CPI from the value date to the current date. Since the CPI is always changing, dated nonmonetary values have to be real valued (updated) all the time and dated monetary values have to be real valued (updated) to show their real value at a date in the past at the current rate—when this is required. Actual money and monetary values in actual ledger accounts can not be updated.

The first part of this invention provides a method and system with steps for the entering/recording/capturing/saving/storing of economic values in computer files/forms in a format ready for accessing by the second part of this invention which provides a method and a system with steps for the reading/accessing of these dated values and the continuous updating (increasing, hyperincreasing or decreasing, as the case may be) of (i) dated nonmonetary values to maintain said dated nonmonetary values at constant real economic values over time and (ii) dated monetary values only to indicate the latters' real values in the past at the current rate when this is required, when displaying and/or printing them and/or making them known to an economic entity in any way or form.

Real values of nonmonetary values in general, and monetary values at a specific date in the past, are maintained at constant real values over time by applying a general price index, namely the Consumer Price Index. With the application of this invention, the continuous availability of the latest level of the CPI in all computer applications is as important as the correct time of day. This invention contains steps for entering the required previous values and the latest value of the CPI in all applications that use this invention. The CPI is as essential as the time of day. Since we do not have stable money but we live in a world with depreciating, hyperdepreciating and appreciating money, we only know the current value of nonmonetary values when we know the current value of our depreciating, hyperdepreciating or appreciating money. We need to know the latest level of the CPI in order to know the value of all real values. This invention contains steps for making the latest level of the CPI available in a computer or computer network just like the time of day. This level of the CPI is then available to all applications running on a computer or computer network to real value enable dated economic values made available by these applications when these dated economic values are displayed, printed or made available in any way. This invention also contains steps for updating the level of the CPI in each particular computer application of which this invention forms a part of.

This invention is not a Real Value Accounting program. Computer applications based on the Real Value Accounting practice are used to update accounting values that form part of a double entry accounting program. Economic values real value enabled using the present invention are foreseen to be automatically entered into Real Value Accounting applications as an when required—and vice versa.

### BRIEF SUMMARY

It is an object of the present invention to provide a user with a system and method with steps for the capturing/entering/recording/inputting of economic values as either nonmonetary or monetary values in computer files always together with value dates and then for continuously updating (i) dated nonmonetary values to maintain said dated nonmonetary values at constant real economic values over time and (ii) dated monetary values only to indicate the latters' real values in the past at the current rate when this is required, whenever the program accesses them in any way including visual or voice methods and displaying them on any electronic computer device in any form and way including in the form of charts and graphs and when they are printed in a hardcover format or when they are made available in any way including, but not limited to, on a computer screen, a TV screen, computer tablet, PDA or computer sound system, for example

The present invention comprises a system which includes steps for preloading prior and current period values of the Consumer Price Index into a computer and to make the level of the CPI permanently available to real value enabled applications.

A novel feature of the system allows a computer user to enter economic values into word processing or spread sheet or web based or data application files as either dated nonmonetary and dated monetary values to be updated or dated monetary values not to be updated.

A novel feature of the system allows a computer user always to see or to be presented with all nonmonetary values always at their updated current real values as well as the current values of past real values of monetary amounts when so required. Nominal monetary values are indicated as such.

Additional objects, advantages and novel features of the invention will become more apparent to those skilled in the art upon examination of the invention or may be learned by practice of the invention.

### BRIEF DESCRIPTION OF THE DRAWINGS

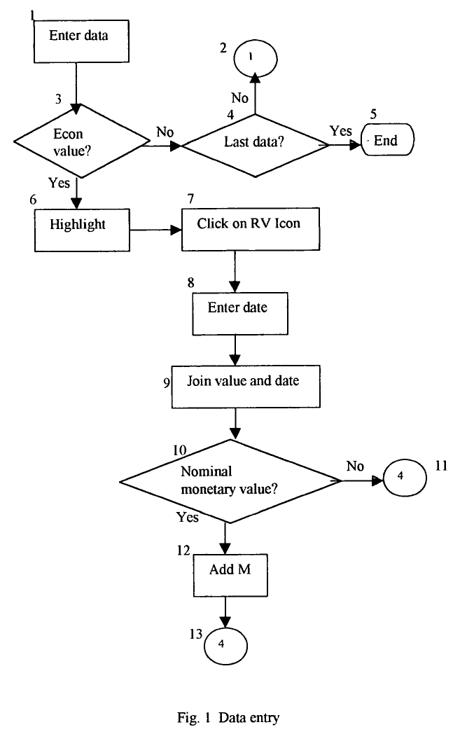

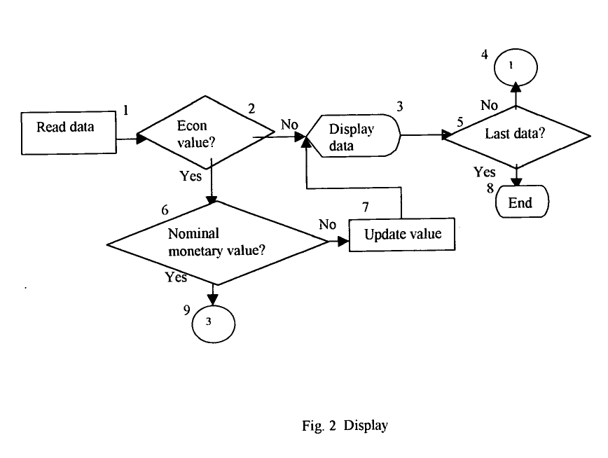

A full understanding of the invention can be gained from the following detailed description when read in conjunction with all the above information in the abstract, the field of the invention, the background and the summary of the invention as well as the accompanying drawings in which FIG. 1 and FIG. 2 are flow charts showing an embodiment of the invention.

### DETAILED DESCRIPTION OF THE INVENTION

The real value enabler is based on the Real Value Principle: The original nominal value of a real value item is to be continuously updated (increased, hyperincreased or decreased) based on the movement in the Consumer Price Index when the monetary unit of measure is depreciating, hyperdepreciating or appreciating money in a cash inflationary, cash hyperinflationary or cash deflationary economy, as applicable.

The present invention relates to a method and system with steps for the capturing/entering/recording/inputting of economic values as either nonmonetary or monetary values in computer files always together with value dates and then for continuously real valuing (updating) (i) dated nonmonetary values to maintain said dated nonmonetary values at constant real economic values over time and (ii) dated monetary values only when it is required to indicate the latters' real values in the past at the current rate, whenever the program accesses them in any way including visual or voice methods and displays them on any electronic computer device in any form and way including in the form of charts and graphs and when they are printed in a hardcover format or when they are made available in any way including, but not limited to, on a computer screen, a TV screen, computer tablet, PDA or computer sound system, for example.

In an embodiment of the present invention, the system is windows-based and menu-driven.

In an embodiment of a feature of the present invention the previous level, as far back as required and available, as well as the current level of the applicable Consumer Price Index is preloaded on a computer network system or in an individual computer to make it available to all real value enabled applications on the network or individual computer or otherwise it is preloaded into every real value enabled application on each individual computer, that is, that uses this invention.

In an embodiment of the present invention a user uses this invention as part of a word processing or a spread sheet or other computer application to enter economic values in a computer file to be displayed or printed afterwards by the same computer application or by any other computer application by which the file can be accessed, for example, internet browsers and any other computer file readers, all of which are real value enabled to display or print the file or make its content available in a real value format including in the form of charts and graphs. Every economic value is entered as either a nonmonetary value with a value date or a monetary value with a value date. When all values to be entered are current nonmonetary values the invention contains steps for the automatic addition of the current date to the current nonmonetary values entered in the file. When this is not the case each economic value entered is entered with a specific value date at which the economic value is or was current which can be the original value date or a later value date at which the original value was real valued (updated) when that later updated value is entered.

In an embodiment of the present invention a user uses this invention as part of a word processing or a spread sheet or an internet browser or file reader or other computer application for continuously real valuing (updating) (i) dated nonmonetary values to maintain said dated nonmonetary values at constant real economic values over time and (ii) dated monetary values only to indicate the latters' real values in the past at the current rate when this is required, whenever the program accesses them in any way including visual or voice methods and displays them on any electronic computer device in any form and way including in the form of charts and graphs and when the program prints them in a hardcover format or when they are made made available in any way including, but not limited to, on a computer screen, a TV screen, computer tablet, PDA or computer sound system, including in the form of real value charts and graphs for example all forms or charts and graphs of the Dow Jones indexes, all other stock and other indexes and share prices, all price charts and all nonmonetary charts and graphs.

The original/past value dates and values of updated values are not displayed or printed or made available in any way when updated values are displayed or printed or made available at the current rate in any way or form. The present invention contains steps for the original/past value dates and values of updated values to be made available as a separate special additional request option.

These features of the present invention thus permit the problem of not being able to update economic values because their original value dates and the required values for the CPI are not electronically available together in the same application or computer or network, to be solved. The best mode of these features of the present invention is the real value enablement of all economic values availble in electronic computer format by the use of this invention with all computer applications that display or print or make economic values available, for example, word processing or spread sheet or internet browser or any file display or chart or print applications.

The practical application of these features is the real value enablement of all economic values when they are entered in word processing or spread sheet or internet browser or any file display or chart or print computer applications that incorporate this invention and then the presentation/displaying/printing of all dated nonmonetary values at continuously updated current values as well as the presentation/displaying/printing of dated monetary values at the current values of their past real values when required.

Once a nonmonetary value is real value enabled with this invention in a computer file it will afterwards always only be displayed or printed or made available at its current real value over time when it is displayed/printed/presented by a real value enabled application. This is essential for all nonmonetary values as explained above.

Once a monetary value is real value enabled at a particular date in a computer file its real value at the past date will afterwards always only be displayed or printed or made available at its current real value over time when it is accessed by a real value enabled application. This is required when the program has to show the real value of past monetary balances or amounts at the current rate. Actual money or monetary values can not be updated. The program simply only shows what a monetary value was worth in the past at today's rate.

Once a monetary value is indicated as a monetary value with this invention in a computer file, it will afterwards only be displayed or printed or made available at its original nominal monetary value when it is accessed by a real value enabled application.

This invention solves the problem of the presentation of nonmonetary values at their, sometimes meaningless and often misleading, historical cost values. The best mode and practical application of this invention is the presentation of all nonmonetary values in computer format at continuously updated current values as well as the presentation of required monetary values at the current values of their past real values.

References will now be made in detail to an embodiment of the present invention in a word processing application, an example of which is illustrated in the accompanying drawings.

FIG. 1 shows an outline of the data entry routine. A new window is opened and data in the form of text and economic values are entered in box 1. The user enters a value and the decision is made by the user that it is an economic value as indicated by the decision diamond 3. In box 6 the user highlights the economic value and in box 7 the user clicks on the RV icon in the standard word processing toolbar to indicate that it is an economic value. In box 8 a small Real Value window opens with a space to enter the date. The user enters the value date of the economic value. In box 9 the program joins the value and the date in a single field which real value enables the economic value as it will now be able to be updated to the current rate before it is displayed or printed or made available in any way by any real value enabled program or application in the future. In the same Real Value window the user indicates whether the value is a nominal monetary value or not as indicated by decision diamond 10. When the economic value is a nonmonetary value the user selects No and the program passes via connector 11 to decision diamond 4 from where it either passes to data entry box 1 when more data need to be entered or when it was the last data entered it passes to End at 5. The user also selects No at decision diamond 10 when the economic value is a monetary value at the date indicated and the user wishes the real value of the monetary value at the value date to be displayed or printed or made available in the future at the future current value of the dated real value of the monetary value. When the economic value entered by the user is a monetary value and the user wishes it to be displayed or printed or made available in the future always only at its dated nominal value then the user selects Yes at decision diamond 10 and the program passes to box 12 where the program adds an M to the already real value enabled field and it becomes an alpha-numeric field indicating a nominal monetary value not to be updated over time. The program then passes to connector 13 where the program is directed to decision diamond 4.

FIG. 2 shows an outline of an embodiment of the present invention in the display routine of a word processing application. When a document is displayed the program reads the data in the data file in box 1. The program passes to decision diamond 2 where the program determines whether the datum read is an economic value or not. When it is not an economic value the program passes to display 3 where the datum is displayed. When the datum is an economic value the program passes from decision diamond 2 to decision diamond 6 where the program determines whether the economic value is a nominal monetary value not to be updated. When the economic value is a nominal monetary value the progam proceeds to connector 9 from where it is directed to display 3 where the nominal monetary value is displayed at its historical nominal value. When the economic value is not a nominal monetary value the program passes from decision diamond 6 to box 7 where the economic value is updated by increasing, hyperincreasing or decreasing the economic value in terms of the increase, hyperincrease or decrease of the Consumer Price Index from the economic value's value date to the current date. The program then passes to display 3 where the updated value is displayed.

The updated value is only used for display purposes in this case. The original saved value and original saved value date of the economic value are not changed in the data file.

While specific embodiments of the invention have been disclosed, it will be appreciated by those skilled in the art that various modifications and alterations to those details could be developed in light of the overall teachings of the disclosure. Accordingly, the particular arrangements disclosed are meant to be illustrative only and not limiting as to the scope of the invention.

What is claimed is:

1. A method and system with steps for the entering of economic values as either nonmonetary or monetary values in electronic format in all computer files and electronic display formats always together with value dates and then for continuously real valuing (updating) (i) dated nonmonetary values to maintain them at constant real economic values over time and (ii) dated monetary values only to indicate the latters' real values in the past at the current rate when this is required, whenever the program accesses them in any way including visual or voice methods and displaying them on any electronic computer or any other electronic device in any form and way including in the form of charts and graphs and when they are printed in a hardcover format or when they are made available in any way including, but not limited to, on a computer screen, a TV screen, mobile phone, computer tablet, PDA or computer sound system;
providing for the previous level, as far back as required and available, as well as the current level of the applicable Consumer Price Index to be preloaded on a computer network system or in an individual computer to make it available to all real value enabled applications on the network or individual computer or otherwise it is preloaded into every real value enabled application on each individual computer, that is, that uses this invention;
providing for a user to use this invention as part of a word processing or a spread sheet or other computer application to enter economic values in a computer file to be displayed or printed afterwards by the same computer application or by any other computer application by which the file can be accessed, for example, internet browsers and any other computer file readers, all of which are real value enabled to display or print the file or make its content available in a real value format including in the form of charts and graphs. Every economic value is entered as either a nonmonetary value with a value date or a monetary value with a value date. When all values to be entered are current nonmonetary values the invention contains steps for the automatic addition of the current date to the current nonmonetary values entered in the file. When this is not the case each economic value entered is entered with a specific value date at which the economic value is or was current which can be the original value date or a later value date at which the original value was real valued (updated) when that later updated value is entered;
providing for a user to use this invention as part of a word processing or a spread sheet or an internet browser or file reader or other computer application for continuously real valuing (updating) (i) dated nonmonetary values to maintain said dated nonmonetary values at constant real economic values over time and (ii) dated monetary values only to indicate the latters' real values in the past at the current rate when this is required, whenever the program accesses them in any way including visual or voice methods and displays them on any electronic computer device in any form and way including in the form of charts and graphs and when the program prints them in a hardcover format or when they are made made available in any way including, but not limited to, on a computer screen, a TV screen, computer tablet, PDA or computer sound system, including in the form of real value charts and graphs for example all forms or charts and graphs of the Dow Jones indexes, all other stock and other indexes and share prices, all price charts and all nonmonetary charts and graphs;
providing for original/past value dates and values of updated values not to be displayed or printed or made available in any way when updated values are displayed or printed or made available at the current rate in any way or form. The present invention contains steps for the original/past value dates and values of updated values to be made available as a separate special additional request option;
providing for the problem of not being able to update economic values because their original value dates and the required values for the CPI are not electronically available together in the same application or computer or network, to be solved;
providing for the real value enablement of all economic values availble in electronic computer format by the use of this invention with all computer applications that display or print or make economic values available, for example, word processing or spread sheet or internet browser or any file display or chart or print applications;
providing for the real value enablement of all economic values when they are entered in word processing or spread sheet or internet browser or any file display or chart or print computer applications that incorporate this invention and then the presentation/displaying/printing of all dated nonmonetary values at continuously updated current values as well as the presentation/displaying/printing of dated monetary values at the current values of their past real values when required;
providing for that once a nonmonetary value is real value enabled with this invention in a computer file it will afterwards always only be displayed or printed or made available at its current real value over time when it is displayed/printed/presented by a real value enabled application;
providing for that once a monetary value is real value enabled at a particular date in a computer file its real value at the past date will afterwards always only be displayed or printed or made available at its current real value over time when it is accessed by a real value enabled application. This is required when the program has to show the real value of past monetary balances or amounts at the current rate. Actual money or monetary values can not be updated. The program simply only shows what a monetary value was worth in the past at today's rate;
providing for that once a monetary value is indicated as a monetary value with this invention in a computer file, it will afterwards only be displayed or printed or made available at its original nominal monetary value when it is accessed by a real value enabled application;
providing for solving the problem of the presentation of nonmonetary values at their, sometimes meaningless and often misleading, historical cost values. The best mode and practical application of this invention is the presentation of all nonmonetary values in computer format at continuously updated current values as well as the presentation of required monetary values at the current values of their past real values;
providing for an embodiment of the present invention in a word processing application, an example of which is illustrated in the accompanying drawings.
FIG. 1 shows an outline of the data entry routine. A new window is opened and data in the form of text and economic values are entered in box 1. The user enters a value and the decision is made by the user that it is an economic value as indicated by the decision diamond 3. In box 6 the user highlights the economic value and in box 7 the user clicks on the RV icon in the standard word processing toolbar to indicate that it is an economic value. In box 8 a small Real Value window opens with a space to enter the date. The user enters the value date of the economic value. In box 9 the program joins the value and the date in a single field which real value enables the economic value as it will now be able to be updated to the current ate before it is displayed or printed or made available in any way by any real value enabled program or application in the future. In the same Real Value window the user indicates whether the value is a nominal monetary value or not as indicated by decision diamond 10. When the economic value is a nonmonetary value the user selects No and the program passes via connector 11 to decision diamond 4 from where it either passes to data entry box 1 when more data need to be entered or when it was the last data entered it asses to End at 5. The user also selects No at decision diamond 10 when the economic value is a monetary value at the date indicated and the user wishes the real value of the monetary value at the value date to be displayed or printed or made available in the future at the future current value of the dated real value of the monetary value. When the economic value entered by the user is a monetary value and the user wishes it to be displayed or printed or made available in the future always only at its dated nominal value then the user selects yes at decision diamond 10 and the program passes to box 12 where the program adds an M to the already real value enabled field and it becomes an alpha-numeric field indicating a nominal monetary value not to be updated over time. The program then passes to connector 13 where the program is directed to decision diamond 4;
providing for an embodiment of the present invention in the display routine of a word processing application as outlined in FIG. 2. When a document is displayed the program reads the data in the data file in box 1. The program passes to decision diamond 2 where the program determines whether the datum read is an economic value or not. When it is not an economic value the program passes to display 3 where the datum is displayed. When the datum is an economic value the program passes from decision diamond 2 to decision diamond 6 where the program determines whether the economic value is a nominal monetary value not to be updated. When the economic value is a nominal monetary value the progam proceeds to connector 9 from where it is directed to display 3 where the nominal monetary value is displayed at its historical nominal value. When the economic value is not a nominal monetary value the program passes from decision diamond 6 to box 7 where the economic value is updated by increasing, hyperincreasing or decreasing the economic value in terms of the increase, hyperincrease or decrease of the Consumer Price Index from the economic value's value date to the current date. The program then passes to display 3 where the updated value is displayed.
The updated value is only used for display purposes in this case. The original saved value and original saved value date of the economic value are not changed in the data file.
